(19) United States
(12) Patent Application Publication
(10) Pub. No.: US 2012/0153001 A1
(43) Pub. Date: Jun. 21, 2012

(54) ELECTRICALLY POWERED BOLT SETTING DEVICE

(75) Inventors: Klaus Bertsch, Frastanz (AT); Harald Fielitz, Lindau (DE); Karl Franz, Feldkirch (AT); Matthias Blessing, Frastanz (AT); Ulrich Schiestl, Hohenems (AT)

(73) Assignee: Hilti Aktiengesellschaft, Schaan (LI)

(21) Appl. No.: 13/325,377

(22) Filed: Dec. 14, 2011

(30) Foreign Application Priority Data
Dec. 15, 2010 (DE) 102010063176.0

(51) Int. Cl. B25C 1/00; B25C 1/06; B25C 1/08; B25C 1/04

(52) U.S. Cl. 227/2; 227/146; 173/1

(57) ABSTRACT

The invention relates to an electrically powered bolt setting device (1) for setting of fastening elements (3) with a spring unit (10) which acts as an intermediate energy store in order to store energy, originating from an electric drive (25), in the bolt setting device (1), and said energy can be released suddenly during a bolt setting process.

In order to create an electrically powered bolt setting device which has a simple design and can be produced at low cost and/or is low in cost to operate, the spring unit (10) cooperates with a unit to adjust the interim-stored energy.

### TECHNICAL FIELD

The invention relates to an electrically powered bolt setting device for setting of fastening elements with a spring unit which acts as an intermediate energy store in order to store energy, originating from an electric drive, in the bolt setting device, said energy can be released suddenly during a bolt setting process, characterized in that the spring unit cooperates with a unit to adjust the interim-stored energy.

### PRIOR ART

Now the electrically powered bolt setting device relates preferably to a hand-operated driving device for fastening elements, such as that disclosed in German Patent Disclosure DE 10 2006 000 517 A1, for example. A similar driving device with a control unit comprising at least one timer is known from the international publication WO 2007/142997 A2. The timer monitors the time needed for a partial or complete recoil stroke, for example. A bolt setting device that is powered by liquid fuel and comprises an automatic control unit for adjusting of the setting parameters for a setting process is known from German Patent Specification DE 103 19 647 B3. The setting parameters are adjustable as a function of data determined by a laser unit from a coding device. Likewise, a fuel-powered bolt setting device that comprises a device for axial displacement of a piston-stop element is known from German Patent Disclosure DE 10 2004 044 156 A1.

### DISCLOSURE OF THE INVENTION

The objective of the invention is to create an electrically powered bolt setting device according to the preamble of claim 1 that has a simple design and is low in cost to produce and/or to operate.

The problem of an electrically powered bolt setting device for setting of fastening elements with a spring unit which acts as an intermediate energy store in order to store energy, originating from an electric drive, in the bolt setting device, where energy can be released suddenly during a bolt setting process, is solved in that the spring unit cooperates with a unit to adjust the interim-stored energy. Depending on the used fastening elements and/or on the subsurface into which the fastening elements are set with the bolt setting device, more or less energy is needed in order to drive the fastening elements into the subsurface.

From German Patent Specification DE 103 19 647 B3 and German Patent Disclosure DE 10 2004 044 156 A1, various methods are known for regulating the setting energy produced by fuel-powered bolt setting devices. These solutions cannot be readily transferred to electrically powered bolt setting devices. According to one essential aspect of the invention, the spring unit of the electrically powered bolt setting device cooperates with the unit to adjust the interim-stored energy such that the spring unit is tensioned differently for different setting processes, and/or such that different size paths are made available to the spring unit for relaxation. Thus the interim-stored energy in the spring unit can be adjusted according to requirements in a simple manner, both manually, for example by use of a switching unit, and also automatically, for example, by use of a control unit.

One preferred embodiment of the electrically powered bolt setting device is characterized in that the spring unit cooperates with the unit to adjust the interim-stored energy such that before the bolt setting process, the spring unit is either not completely tensioned and/or is not completely relaxed during the bolt setting process. Preferably the spring path of the spring unit is adjusted herein. The spring path of the spring unit can be adjusted at one end of the spring unit, which comprises at least one coil compression spring, for example, or at both ends of the spring unit.

An additional preferred embodiment of the electrically powered bolt setting device is characterized in that the unit to adjust the interim-stored energy has a controlling connection to the electric drive such that, depending on the bolt setting parameters and/or on the type of fastening elements to be set, more or less energy is supplied to the spring unit. The unit to adjust the interim-stored energy is connected to the electric drive preferably by means of a control unit. The electric drive is used, for example, with a belt drive circuited in between, to tension the spring unit. Depending on how tightly the spring unit is tensioned by means of the electric drive, more or less interim energy is stored in the spring unit.

An additional preferred embodiment of the electrically powered bolt setting device is characterized in that a control device has a controlling connection to a buffer- and/or brake unit such that a pounder being moved suddenly in a translational direction by means of the spring unit and being used for setting of the fastening elements, traverses a more or less large setting path during a bolt setting process. The spring unit can be tensioned preferably via a threaded spindle and a torsion-resistant spindle nut guided on the threaded spindle. Thus a rotational movement of the threaded spindle created by the electric drive, for example, will be converted into a linear movement or translational movement of the spindle nut. The spring unit can also be tensioned in another manner.

An additional preferred embodiment of the electrically powered bolt setting device is characterized in that the unit to adjust the interim-stored energy has a controlling connection to a manually operable switching unit on the bolt setting device and/or to a and/or to the control unit in the bolt setting device. By means of the switching unit, a user can adjust externally on the bolt setting device how much interim energy is to be stored in the spring unit or is to be released from the spring unit. The same can also be adjusted automatically by means of the control unit.

An additional preferred embodiment of the electrically powered bolt setting device is characterized in that a and/or the control unit has a controlling connection to a detection unit, in particular to a subsurface detection unit, to a buffer stress detection unit, to a nail protrusion detection unit and/or to a recoil detection unit. The unit to adjust the interim-stored energy detects the type and/or nature of the subsurface, for example, by means of radar technique and/or ultrasonic technique. By using radar technique, in particular, the distance between the bolt setting device and the surface of the subsurface can be determined. The buffer loading can be detected, for example, by means of strain gauges or piezoelements. The nail protrusion is defined as that distance by which a fastening element extends from the subsurface after the setting process. The nail protrusion can be determined inductively, or by means of a potentiometer, for example. Alternatively or additionally, conventional distance measuring devices can be used to determine the nail protrusion, for example. The recoil of the bolt setting device when setting a fastening element can be detected, for example, by means of acceleration sensors.

An additional preferred embodiment of the electrically powered bolt setting device is characterized in that the unit to adjust the interim-stored energy comprises an electronic adjusting unit. The individual parts of the bolt setting device, which are installed in the drive chain of the bolt setting device, exhibit manufacturing-induced tolerances. These tolerances necessarily mean that the final assembled bolt setting devices in a defined operating state do not always store exactly the same amount of interim energy in the spring unit. By means of the adjusting device according to the invention, the assembled bolt setting devices upon initial commissioning operation can be adjusted in a simple manner so that each bolt setting device in a defined operating state will store the same amount of interim energy in the spring unit.

An additional preferred embodiment of the electrically powered bolt setting device is characterized in that the electronic adjusting unit has an adjusting connection to the spring unit so that at least one end position of the spring unit is adjustable. With the electronic adjusting unit, preferably the spring path is adjusted in a defined operating state of the bolt setting device.

According to another embodiment example, the energy store has a dynamic energy store, in particular a flywheel. Thus the stored energy can be adjusted preferably by means of the rotational speed.

In accordance with an additional embodiment example, the spring unit features a mechanical spring, in particular a coil spring. Preferably, the mechanical spring is produced essentially of a steel, a plastic and/or an elastomer. According to an additional embodiment example, the spring unit features a pneumatic and/or hydraulic spring, in particular a gas spring.

In accordance with an additional embodiment example, the drive energy is adjusted by adjusting the spring characteristic of the spring unit, instead of or in addition to the adjustment of the spring path. In particular in the case of a gas spring, this is effectuated preferably by a change to the internal pressure and/or the volume, for example in the form of volumes added in via valves, or even by changing the structure of the spring, for example, in the form of variable throttle settings which generate different pressure losses during the relaxation of the gas spring.

In a method for operation of a bolt setting device, preferably of an electrically powered bolt setting device of the kind described above, the objective stated above is alternatively or additionally solved in that an energy store of the bolt setting device, in particular the spring unit, is either not fully loaded or tensioned before a bolt setting process, and/or is not completely unloaded or relaxed in a setting process. Thus it is possible in a simple manner to adjust the interim-stored amount of energy, or the amount of energy of the energy store or of the spring unit, respectively, released in a bolt setting process.

A preferred embodiment of the method is characterized in that more or less energy is interim-stored in the energy store, in particular in the spring unit, depending on the bolt setting parameters and/or on the type of fastening elements to be set. The interim-stored amount of energy is adjusted, for example, automatically via the control unit or manually by a user.

An additional preferred embodiment of the method is characterized in that the energy store, in particular the spring unit, is discharged by a defined amount of energy before a bolt setting process, in particular is relaxed by a defined spring path in order to reduce the interim-stored energy before the bolt setting process. Relaxation of the spring unit can be effected, for example, by means of the electric drive. Thus it is possible to convert the interim energy released upon relaxation of the spring unit back into electric energy via the electric drive.

An additional preferred embodiment of the method is characterized in that a pounder driven by the energy store, in particular by the spring unit and used for setting of the fastening elements, traverses a more or less large setting path in a setting process. The bolt setting path of the pounder can be varied, for example, by a buffer- and/or brake device.

The objective stated above—in a method for initial operation of an electrically powered bolt setting device of the kind described above—is alternatively or additionally solved in that drive elements downstream from the electric drive are sized and adjusted after the assembly of the bolt setting device. Thus tolerance-related differences can be compensated by means of simple and low-cost elements, such as belt tighteners, shims and such. By using these elements, it is possible in a very simple manner for each bolt setting device to store the same amount of interim energy in defined operating states.

The problem in the case of a gas-powered bolt setting device with a combustion chamber to convert chemical energy of the combustion gas into setting energy of a fastening element, with an electrically controllable valve for dosing of combustion gas into the combustion chamber, with an electrical control unit to control a quantity of fuel dosed from the valve into the combustion chamber, is solved in that the control unit is provided for determining the quantity of fuel dosed into the combustion chamber on the basis of data which are determined by a detection unit, in particular a subsurface detection unit, a buffer load detection unit, a nail protrusion detection unit and/or a recoil detection unit, and transferred to the electrical control unit.

The problem in the case of a compressed-air operated bolt setting device with a storage chamber for storage of compressed air which is provided for driving a fastening element into a substrate by means of a sudden relaxation thereof, with an electrically controllable valve for adjusting of a pressure in the storage chamber, with an electrical control unit to control the pressure adjusted by the valve in the storage chamber, is solved in that the control unit is provided to determine the pressure to be adjusted in the storage chamber on the basis of data which are determined by a detection unit, in particular a subsurface detection unit, a buffer load detection unit, a nail protrusion detection unit and/or a recoil detection unit, and transferred to the electrical control unit.

Under certain circumstances, due to the present invention, a fully-automatic energy adjustment is possible. That is, a user of the invented bolt setting device need not decide what drive energy is selected for the next driving process. The device will make this decision for the user. Because the optimum driving energy is used for each fastening point, the fastening quality is improved. For example, the tendency to fracture masonry due to excessive driving energy can be reduced. Also, under certain circumstances, less excess energy has to be dissipated in the bolt setting device, so that the corresponding components, in particular the buffer for deceleration of the driving pounder, will be relieved. This increases the service life of the device and/or of the components and thus the bolt setting device can be dimensioned smaller and/or of lighter construction. For example, any potentially present electric energy store can be spared since only the energy needed for driving in the fastening element need be withdrawn from said energy store. Thus, under certain circumstances, the range of the electric energy store, such as a storage battery, will be increased.

Additional advantages, features and details of the invention are indicated in the following description which describes in greater detail the various embodiment examples by reference to the figures.

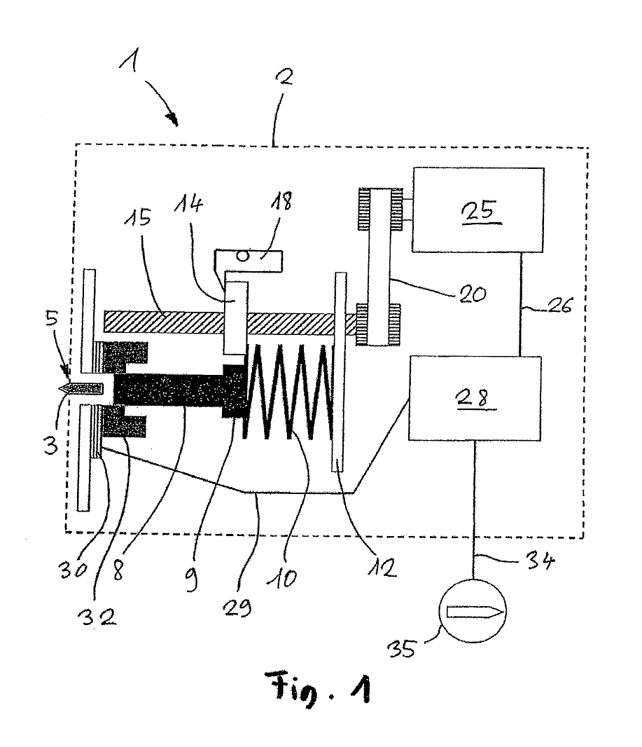

FIG. 1 A simplified representation of a bolt setting device according to the invention with interim-energy adjustment via a buffer device;

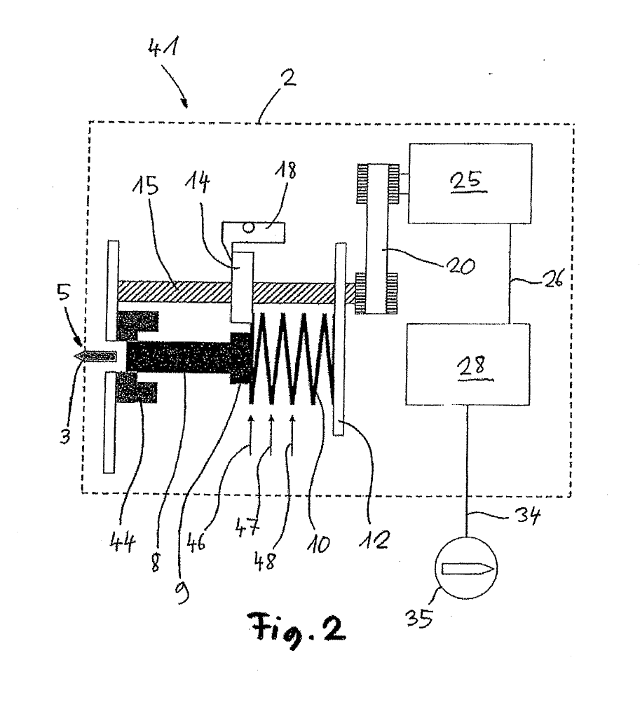

FIG. 2 A similar bolt setting device as in FIG. 1, with an interim-energy adjustment via a spring path of a spring unit and

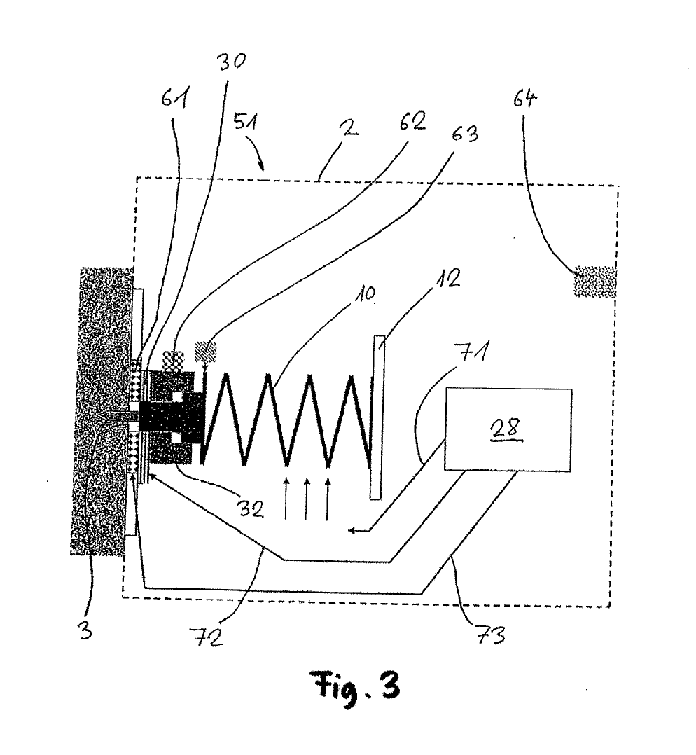

FIG. 3 A similar bolt setting device as in FIGS. 1 and 2 with additional detection units which have a controlling connection to a control unit for adjusting the interim energy.

### EMBODIMENT EXAMPLES

The bolt setting device according to this invention is a hand-held driving device, for instance, like that disclosed in FIGS. 1-4 of the associated description of German Patent Disclosure DE 10 2006 000 517 A1. The bolt setting device comprises a spring as a driving spring element and is thus also designated as spring nailer. The spring is tensioned by an electric motor which drives a recirculating ball screw via a toothed belt or a gear wheel- or friction-wheel transmission. A rotational movement of the threaded spindle is converted into a linear movement of the spindle nut via a spindle nut mounted in a rotationally secured manner to the threaded spindle.

FIGS. 1-3 present a bolt setting device 1; 41; 51 with a housing 2 shown in a simplified cross section. The bolt setting device 1; 41; 51 comprises a magazine for fastening elements 3, in particular bolts—a supply is held in the magazine. The bolt setting device 1; 41; 51 further comprises a handle which can be grasped with the user's hand. The fastening element 3 is driven into the subsurface by means of a pounder 8 which has a head 9 at its end facing away from the fastening element 3. A spring unit 10 is pressed against the head 9.

For setting of a fastening element 3, the bolt setting device 1; 41; 51 is placed by one bolt setting end 5 against a wall or ceiling, for example. The bolt setting device 1; 41; 51 has a spring unit 10 as interim storage for the interim-storing of propulsion energy which can be suddenly released in a bolt setting process in order to set a bolt 3. The spring unit 10 comprises, for example, a coil compression spring which can be placed under differing tension in order to store interim energy. The spring unit 10 is tensioned between a spring seat 12 and a spindle nut 14. The spring path of the spring unit 10 can be varied by means of the distance between the spring seat 12 and the spindle nut 14.

A threaded spindle 15 can rotate in the spindle nut 14. The threaded spindle 15 is rotatably mounted in the housing 2 and is driven via a belt drive 20 and electric drive unit 25. The electric drive unit 25 comprises an electric motor. By a rotation of the threaded spindle 15, it is possible to move the spindle nut 14 and, if necessary, the spring seat 12 in an axial direction, that is, parallel to the longitudinal axis of the threaded spindle 15. Thus the spring path of the spring unit 10 can be adjusted in a simple manner. Due to the electric drive 25, the spring unit 10 can be compressed via the spindle nut 14, so that the pounder 8 assumes a setting position illustrated in FIG. 1. When the spring unit 10 and/or the spindle nut 14, respectively, is released by a pawl 18, the spring unit 10 is suddenly released and the interim energy stored in the spring unit 10 is dispensed in order to set the fastening element 3.

The electric drive 25 has a controlling connection to a control unit 28 via a control line 26. In turn, the control unit 28 has a controlling connection to a buffer actuator 30 of a buffer unit 32 via an additional control line 29. The buffer unit 32 comprises a buffer whose distance to the spring unit 10 is adjustable by means of the buffer actuator.

The control unit 28 has a controlling connection to a switching unit 35 via an additional control line 34; the switching unit is attached externally to the bolt setting device 1 and can be actuated externally. The buffer actuator 30 and/or the electric drive 25 can be adjusted manually by a user by means of the switching unit 35.

Thus the user can adjust the electric drive 25, for example, the electric drive power or the duration of the electric drive 25, manually and externally. Moreover, the user can adjust the buffer actuator 30 manually and externally via the switching unit 35 and the control unit 28, so that the buffer of the buffer unit 32 is adjusted toward or away from the spring unit 10.

During operation of the bolt setting device 1; 41; 51, the spring unit 10 is tensioned via the electric drive. Thus the threaded spindle 15 designed as recirculating ball screw is driven via the belt drive 20. The rotational movement of the threaded spindle 15 is converted by the rotationally secured spindle nut 14 into a linear movement. The spring unit 10 is tensioned via the linearly moved spindle nut 14 in that the pounder 8 resting against the spring unit 10 is moved from the spindle nut 14 against the spring unit 10 so that the spring path thereof is shortened. At the end of the tensioning movement of the spring unit 10, the spindle nut 14 or the pounder 8 or the spring unit 10, respectively, engages in the pawl 18 and is held in the tensioned position.

The spindle nut 14 with tensioned spring unit 10 is then moved by the electric drive 25 into its starting position in the reverse direction of rotation of the threaded spindle 15. The spring unit 10 is held in its tensioned position until an operator or a user of the bolt setting device 1 opens the pawl 18 by pressing a trigger and thus initiates a bolt setting process in which the spring unit 10 is suddenly relaxed. The interim energy stored in the spring unit is then transferred via the pounder 8 to the fastening element 3 at the bolt setting end 5 of the bolt setting device 1.

After the setting process, the spring unit 10 is tensioned again, in that the process previously described is executed anew. Due to the controlling connection of the control unit 28 with electric drive 25, to the buffer actuator 30 and/or to the switching unit 35, according to one essential aspect of the invention, a unit to adjust the interim-stored energy is created with which the spring unit can be either incompletely tensioned or incompletely relaxed during operation of the bolt setting device 1 and as a function of the bolt setting parameters and/or of the particular subsurface. By means of the control unit 28, the amount of interim energy saved in the spring unit 10 can be adjusted in a simple manner as needed.

The amount of bolt setting energy released by the bolt setting device 1 depends on how the movement energy and on how much movement energy of the pounder 8 is transferred to the fastening element 3. The amount of energy released from the pounder 8 can be limited in that the pounder 8 is not accelerated across the entire available length. This can be effected, for example, in that the spring unit 10 is not tensioned over the entire available path. Alternatively, the spring unit 10 can also first be relaxed for a certain path and only thereafter be disengaged.

Due to an adjustment of the position of the buffer unit 32 by means of the buffer actuator 30, the amount of movement energy released by the pounder 8 can likewise be adjusted. By means of the switching unit 35, the user can select, for example, whether a maximum amount of setting energy of one hundred percent is released to the fastening element 3, or only a limited amount of setting energy, for example, fifty or seventy-five percent of the maximum possible amount of setting energy.

The bolt setting device 41 illustrated in FIG. 2 comprises a buffer unit 44 which, in contrast to the embodiment example represented in FIG. 1, is not designed so as to be adjustable. The arrows 46, 47 and 48 in FIG. 2 indicate that the amount of interim energy stored by the spring unit 10 can be adjusted via a change in the acceleration path. By means of the switching unit 35, the user can select a desired amount of energy, for example, fifty percent, seventy-five percent or one hundred percent. Then the corresponding acceleration path 48, 47, 46 is adjusted by means of the control unit 28. Then the pounder 8 will be disengaged and accelerated according to the switch setting in the different positions. Depending on the particular fastening element 3, it may be necessary first to tension the pounder 8 in all cases back to its rear-most position 48 and only thereafter to bring it into its disengage or release position.

In contrast to the preceding embodiment examples, the bolt setting device 51 illustrated in FIG. 3 is additionally equipped with a subsurface detection unit 61, a buffer load detection unit 62, a nail protrusion detection unit 63 and a recoil detection unit 64. The arrow 71 indicates that, due to the control unit 28, different acceleration paths (indicated by unnumbered arrows) can be traversed. An additional arrow 72 indicates that the control unit 28 has a controlling connection to the buffer actuator 30. An additional arrow 73 indicates that the control unit 28 has a controlling connection to the subsurface detection unit 61. The remaining detection units 62-64 have wireless controlling connections to the control unit 28.

The electric drive 25, the belt drive 20, the threaded spindle 15, the spindle nut 14, the pawl 18, the spring unit 10 and the pounder 8 together represent a drive chain which provides the bolt setting energy in order to drive the fastening element 3 into the subsurface. The individual elements of the drive chain are necessarily laden with tolerances due to their manufacture. The amount of setting energy released by the drive chain can be set in a defined operating state after mounting of the bolt setting device 1; 41; 51, and adjusted with adjusting elements such as belt tensioners or washers.

According to an additional aspect of the invention, the bolt setting device 1; 41; 51 comprises an electronic adjusting unit for adjusting the bolt setting energy. The spring unit 10 herein is designed so that the tensioning process of the spring unit 10 can be adjusted, for example, via the electric drive unit 25. After assembly of the bolt setting device 1; 41; 51 or of only the drive chain, the released amount of setting energy can be measured and the control unit 28 can be programmed with this information.

This process can be automated with a final check of the bolt setting device 1; 41; 51 and/or of the drive chain. By means of an electronic adjusting unit according to the invention, low-cost drive elements with relatively large tolerances can be used. By means of the electronic adjusting unit, it can be assured in a simple manner that all devices or drive chains release the same amount of setting energy in a defined operating state.

Of course, all features of the description of the invention and also of the description of the embodiment examples can be combined with each other in any manner. It is expressly pointed out that the invented bolt setting devices are also suitable for other applications, in particular for driving of nails, rivets, pins, dowels and similar fastening elements, into any particular subsurface.

1. An electrically powered bolt setting device for setting fastening elements, comprising an electric drive and a spring unit providing an interim energy store to store energy, originating from the electric drive such that energy can be released suddenly during a bolt setting process, wherein the spring unit cooperates with a unit to adjust the interim-stored energy.

2. The electrically powered bolt setting device according to claim 1, wherein the spring unit cooperates with the unit to adjust the interim-stored energy such that before the bolt setting process, the spring unit is either not completely tensioned and/or is not completely relaxed during the bolt setting process.

3. The electrically powered bolt setting device according to claim 1, wherein the unit to adjust the interim-stored energy has a controlling connection to the electric drive such that, depending on the bolt setting parameters and/or on the type of fastening elements to be set, more or less energy is supplied to the spring unit.

4. The electrically powered bolt setting device according to claim 1, further comprising a control device having a controlling connection to a buffer and/or brake unit such that a pounder being moved suddenly in a translational direction by means of the spring unit and being used for setting of the fastening elements) traverses a more or less large setting path during a bolt setting process.

5. The electrically powered bolt setting device according to claim 1, wherein the unit to adjust the interim-stored energy has a controlling connection to a manually operable switching unit on the bolt setting device and/or to a control unit in the bolt setting device.

6. The electrically powered bolt setting device according to claim 1, wherein control unit has a controlling connection to a detection unit.

7. The electrically powered bolt setting device according to claim 1, wherein the unit to adjust the interim-stored energy comprises an electronic adjusting unit.

8. The electrically powered bolt setting device according to claim 7, wherein the electronic adjusting unit has an adjusting connection to the spring unit so that at least one end position of the spring unit is adjustable.

9. A method for operating the electrically powered bolt setting device of claim 1, wherein before a bolt setting process, the spring unit is not fully loaded, and/or is not completely unloaded.

10. The method according to claim 9, comprising setting bolt setting parameters before operating the device.

11. The method according to claim 9, comprising discharging a defined amount of energy before the bolt setting process, to reduce the interim-stored energy before the bolt setting process.

12. The method according to claim 9, comprising driving a pounder by the spring unit, wherein the pounder traverses a more or less large setting path in the setting process.

13. A method for operating the operation the electrically powered bolt setting device, according to claim 1, comprising sizing and adjusting drive elements downstream from the electric drive after assembly of the bolt setting device.

14. A gas-powered bolt setting device comprising a combustion chamber to convert chemical energy of the combustion gas into energy for setting a fastening element, an electrically controllable valve for dosing of combustion gas into the combustion chamber, and an electrical control unit to control a quantity of fuel dosed from the valve into the combustion chamber, wherein the control unit provides for determining the quantity of fuel dosed into the combustion chamber on the basis of data which are determined by a detection unit, and transferred to the electrical control unit.

15. A compressed-air operated bolt setting device comprising a storage chamber for storage of compressed air for driving a fastening element into a substrate by means of a sudden relaxation thereof, an electrically controllable valve for adjusting of a pressure in the storage chamber, and an electrical control unit to control the pressure adjusted by the valve in the storage chamber, wherein the control unit provides for determining the pressure to be adjusted in the storage chamber on the basis of data which are determined by a detection unit and transferred to the electrical control unit.

16. The electrically powered bolt setting device according to claim 2, wherein the unit to adjust the interim-stored energy has a controlling connection to the electric drive such that, depending on the bolt setting parameters and/or on the type of fastening elements to be set, more or less energy is supplied to the spring unit.

17. The electrically powered bolt setting device according to claim 2, further comprising a control device having a controlling connection to a buffer and/or brake unit such that a pounder being moved suddenly in a translational direction by means of the spring unit and being used for setting of the fastening elements, traverses a more or less large setting path during a bolt setting process.

18. The electrically powered bolt setting device according to claim 3, further comprising a control device having a controlling connection to a buffer and/or brake unit such that a pounder being moved suddenly in a translational direction by means of the spring unit and being used for setting of the fastening elements, traverses a more or less large setting path during a bolt setting process.

19. The electrically powered bolt setting device according to claim 4, wherein the unit to adjust the interim-stored energy has a controlling connection to a manually operable switching unit on the bolt setting device and/or to the control unit in the bolt setting device.

20. The electrically powered bolt setting device according to claim 6, wherein the detection unit comprises a subsurface detection unit, a buffer stress detection unit, a nail protrusion detection unit and/or a recoil detection unit.
